(19) United States
(12) Patent Application Publication
(10) Pub. No.: US 2006/0015224 A1
(43) Pub. Date: Jan. 19, 2006

(54) Systems and methods for delivery of railroad crossing and wayside equipment operational data

(76) Inventor: Thomas N. Hilleary, Kansas City, MO (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 11/181,585

(22) Filed: Jul. 14, 2005

Related U.S. Application Data
(60) Provisional application No. 60/588,079, filed on Jul. 15, 2004.

(51) Int. Cl. G06F 17/00

(52) U.S. Cl. 701/19; 246/1 C

(57) ABSTRACT

A system and method for collecting and delivering operational data relating to railroad grade crossing equipment and wayside equipment is described. The method comprises collecting operational data relating to railroad crossing equipment and wayside equipment in a data server, receiving the operational data from the data server with a data delivery device when the data server is in proximity to the data delivery device, and transmitting the operational data from the data delivery device to an external communication system.

### CROSS REFERENCE TO RELATED APPLICATIONS

This application claims priority of Provisional Application Ser. No. 60/588,079 filed Jul. 15, 2004.

### BACKGROUND OF THE INVENTION

This invention relates generally to railroad operation and, more specifically, to systems and methods for delivery of railroad crossing and wayside equipment operational data.

Railroad grade crossings and other track side (wayside) equipment typically includes electronic devices for operating crossing gates and lights, identifying approaching locomotives, and providing adjacent automotive traffic control equipment with information regarding train movement. These devices are designed to be as fail-safe as possible, for the safety of the public. To try to maximize public safety, department of transportation regulations enforce regular inspection, testing, and record keeping regarding operation of these electronic devices.

With the nature of railroads, these electronic devices are dispersed over a wide geographic area, and every crossing site must be inspected, on site, every month, to verify and record functions such as crossing activation timing, warning light operation and voltage, and shunt detector operation.

Crossing controllers and train predictor devices maintain internal data logs to allow verification of their performance—both as a part of regular maintenance and inspections and in the event of a major or minor equipment malfunction. These logs and data verifying operational history are lengthy, and acquiring these data requires either a costly communications link to the remote site or a trip out to the site with a laptop computer or other portable device in order to connect to the crossing equipment and download the data logs. While the need to acquire and analyze these data is periodic, the availability of this information on a timelier basis is thought to be beneficial, especially if the data can be archived in a manner that allows on-line access by individuals associated with responsibility for operating and maintaining the equipment and the grade crossings.

At the same time there is a desire to reduce the frequency of on-site maintenance inspections and tests. Accordingly, crossing controller and monitoring equipment is becoming available that can automatically conduct tests and store data relating to many, if not all, of the monthly FRA tests. One example of such a test is acquiring and storing performance data during each activation of the crossing equipment. While the automated testing provides a significant time and labor savings, the data must still be retrieved to be of value. Currently, retrieval of such data includes communications through a long distance communication network (telephone, wireless, packet, or other similar data network), or traveling to the equipment site to manually download the operational data event logs relating to the testing data.

A more cost effective solution for amassing this test data at a central point is sought by the industry, to fully realize the savings an automated remote crossing test capability could offer. Currently, railroad organizations are reluctant to install commercially available communications networks in order to gather data and to receive notification of alarm situations from crossings and wayside equipment, due to the high cost and very infrequent use of these networks. In some cases, wayside equipment cannot economically access available wired or wireless data connections. As a result, railroads have resorted to low cost alarm notification systems such as cellular control channel communications equipment that cannot transport the high volume of information associated with operational data event logs resulting from testing activities.

### BRIEF DESCRIPTION OF THE INVENTION

In one aspect, a method for delivery of railroad crossing and wayside equipment operational data is provided. The method comprises collecting operational data relating to railroad crossing equipment and wayside equipment in a data server, receiving the operational data from the data server with a data delivery device when the data server is in proximity to the data delivery device, and transmitting the operational data from the data delivery device to an external communication system.

In another aspect, a system for delivering railroad crossing and wayside equipment operational data is provided. The system comprises at least one data server, at least one data delivery device, and an external communication system. The data servers are configured to collect operational data relating to railroad crossing equipment and wayside equipment, configure the operational data into operational data files, and transmit the operational data files. The data delivery device is configured to receive the operational data files from the data server when the data server is in proximity to the data delivery device and transmit the operational data files. The external communication system comprising at least one of a computer system attached to the data delivery device and a reception point in proximity to the data delivery device. The reception point is communicatively coupled to a computer system, and the external communication system is configured to receive the operational data files and store the operational data files in a database.

### BRIEF DESCRIPTION OF THE DRAWINGS

FIG. 1 is a block diagram illustrating communications between a data server and various railroad crossing and wayside equipment.

FIG. 2 is an illustration of the data server of FIG. 1 transmitting stored test data to a data delivery device mounted on a passing train.

FIG. 3 is an illustration of the data delivery device of FIG. 2 transmitting testing data to a reception point, the reception point configured to communicate on a network to a centralized database.

### DETAILED DESCRIPTION OF THE INVENTION

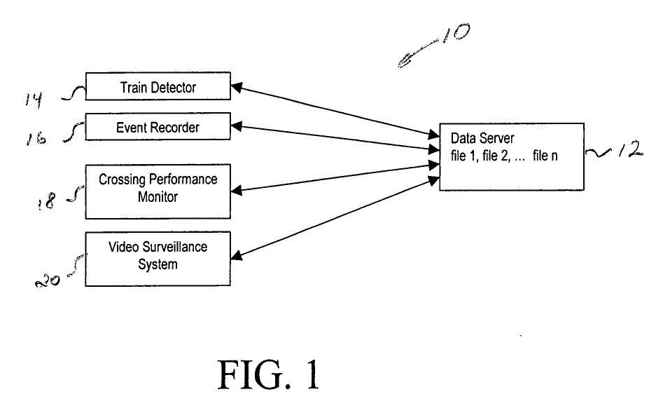

FIG. 1 is a block diagram of a system 10 where the various devices in a railroad grade crossing or wayside equipment enclosure are communicatively connected to a data server (DS) 12. In the embodiment illustrated the various devices include a train detector 14, an event recorder 16, a crossing performance monitor 18, and a video surveillance system 20. In one embodiment, data server 12 communicates with the above described electronic equipment at the site (i.e., crossing or equipment enclosure) to collect operational data files using protocols and sequences that are native to the individual pieces of equipment. Data server 12 includes a memory (not shown) providing an ability to store a high volume of centralized data based on user configured schedules, other triggering data communicated to the site, or generated by other equipment sensing parameters stored within the crossing or wayside equipment. In one embodiment, each operational data file includes a data time stamp and a source equipment identifier. In addition, each operational data file carries a data field that indicates what portions of the file, if any, have been successfully delivered from data server 12 to an external communication system (described below) in a fragmented form.

Examples of data retrieved for later delivery by data server 12, and archiving and analysis by an external system can include crossing activation performance such as times, duration, equipment response times and images, either still or streaming video, to verify crossing equipment performance during crossing activation. Other example data includes external parameters, such as, vehicle detection in the crossing island area, vehicles driving around gates, for instance, from a trapped vehicle monitoring system, and internal parameters, such as, train prediction and gate timing, shunt detection response, commercial power status and battery voltages, and warning light performance, for instance, from a lamp performance monitoring system.

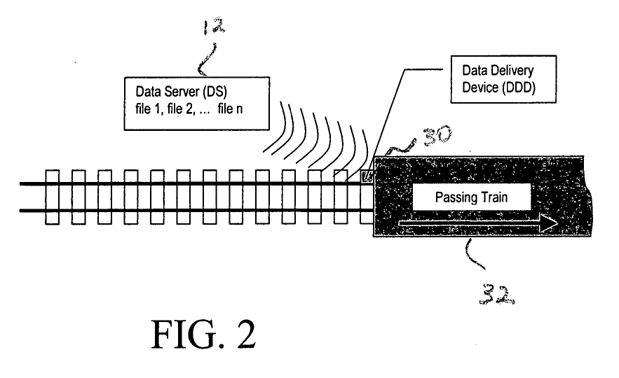

Instead of connecting a high cost communications network to data server 12, in one embodiment, data server 12 stores the operational data files until a data delivery device (DDD) is within proximity, for example, mounted on a train that eventually will travel past the crossing or wayside equipment where data server 12 is located. FIG. 2 illustrates a data server 12 transmitting operational data files to a data delivery device (DDD) 30 which is mounted on a rear of a passing train 32. Upon detection of DDD 30, data server 12 broadcasts as many of the operational data files as it can while DDD 30 is within range. In various embodiments, data server 12 and DDD 30 utilize a spread spectrum radio link or similar short range RF data network, allowing authentication of each file or file segment's reception by DDD 30. Portions of each data file successfully transmitted to any number of passing DDDs 30 is noted by data server 12. For purposes of redundancy, data server 12 causes each file or file fragment to be delivered to a passing DDD 30 more than one time, improving the chances of successful file reconstruction and providing additional means of error detection at a centralized database node in the network, at which wholly-delivered files may be archived and made available through any conventional network means for users and reports.

In one embodiment, the location for DDD 30 is at the end (rear) of the train ‘consist’, for example, as a part of the end of train device (EOT) or redman. The EOT is typically located at the end of the train and contains a flashing red marker light and a terminator for the train's air brake line. It responds to polls from a radio at the head-end of the train by transmitting telemetry including air line pressure and speed of the train measured by GPS location technology. The EOT location provides power sufficient to operate DDD 30, and signals are available, for example, at a grade crossing or other wayside equipment area which inform data server 12 when the last car of a train has passed the boundaries of the grade crossing, thus notifying data server 12 that DDD 30 is in an ideal position to receive stored, undelivered operational data files and data file fragments.

In an alternative embodiment, DDD 30 is located at the head of the train, where a more favorable electronic equipment environment may be found, and where power is also readily available. If DDD 30 is located at the head of train location, different methods of determining the adequate proximity of data server 12 to DDD 30 are employed, such as, continuous or periodic radio polling by data server 12, continuous or periodic radio polling by DDD 30, and reception of the head-of-train transponder by data server 12, typically in the VHF band. Additional methods of determining the adequate proximity of data server 12 to DDD 30 include detection of an audible horn signal of the approaching locomotive (required action by the train operators), and detection of crossing activation signal from the crossing controller equipment (by data server 12).

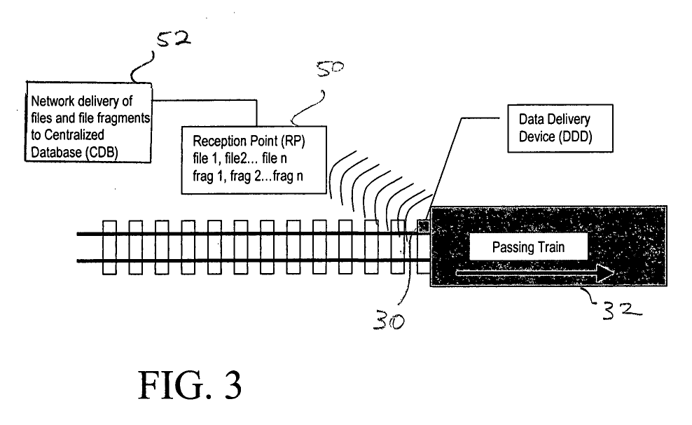

Depending upon the configuration of data server 12, the operational data files that are to be delivered are eventually transmitted, either in whole or in part, to multiple passing DDDs 30. Therefore, the multiple trains passing grade crossings and wayside equipment enclosures equipped with data servers 12 are utilized to collect and transport the operational data files. The trains physically transport harvested data files and file fragments until such time as each train passes in close proximity to designated sites or wayside equipment that include a reception point 50, which is illustrated in FIG. 3. As train 32 passes such reception points 50, the operational data files (in whole or in part) are offloaded from the traveling DDD 30. Reception point 50 utilizes similar methods of detecting the necessary proximity of a DDD 30 loaded with data to a reception point 50 to those described above for determining a proximity of a DDD 30 to a data server 12.

In one embodiment, reception point 50 retrieves the operational data files and data file fragments for delivery through a conventional data network 52 which includes a centralized database. Once the transported operational data has been transmitted to a reception point 50, the DDDs 30 are once again utilized to collect operational data files from other data servers 12 encountered in the continued movement of train 32.

Data files and file fragments from numerous DDDs 30 each collecting operational data from numerous data servers 12 are ultimately delivered to the centralized database through network 52. In one embodiment, the centralized database is a portion of a computer system that is configured to parse all operational data, associate operational data files and file fragments with particular remote sites, eliminate redundant files or fragments, resolve any errors, and reconstruct the original operational data files from each of the remote sites that include a data server 12. Once reconstructed, the complete operational data files then available to users over the Internet or a company intranet to make assessments as to the operation and maintenance of grade crossing and wayside equipment.

In a particular embodiment, a separate, low-cost, low data volume communication system, for example, a cellular control channel based network, can trigger data servers 12 to request and capture operational data logs and event files from crossing equipment in order to sequester data associated with a particular event or time period. In addition, communications between data servers 12 and DDDs 30, and alternatively between DDDs 30 and reception points 50, can utilize one or more forms of wireless data communications, for example, spread spectrum, UHF and VHF, UWB, or light based data communications.

In another embodiment, operational data may be off loaded from DDDs 30 at a locomotive depot level, allowing delivery to a centralized database for reconstruction and consolidation with or without the use of a reception point 50.

While the invention has been described in terms of various specific embodiments, those skilled in the art will recognize that the invention can be practiced with modification within the spirit and scope of the claims.

What is claimed is:

1. A method for delivery of railroad crossing and wayside equipment operational data, said method comprising:
collecting operational data relating to railroad crossing equipment and wayside equipment in a data server;
receiving the operational data from the data server with a data delivery device when the data server is in proximity to the data delivery device; and
transmitting the operational data from the data delivery device to an external communication system.

2. A method in accordance with claim 1 wherein collecting operational data comprises organizing the operational data into operational data files.

3. A method in accordance with claim 2 further comprising encoding in each operational data file a data field that indicates what portions of the file have been successfully delivered from the data server to the external communication system in a fragmented form.

4. A method in accordance with claim 1 wherein the step of receiving the operational data from the data server with a data delivery device further comprises configuring a train with the data delivery device.

5. A method in accordance with claim 1 wherein said step of transmitting the operational data from the data delivery device to an external communication system comprises transmitting the operational data to at least one of a computer system attached to the data delivery device and a reception point in proximity to the data delivery device.

6. A method in accordance with claim 5 wherein transmitting the operational data to a reception point in proximity to the data delivery device further comprises transmitting the operational data from the reception point to the computer system, the computer system communicatively coupled to a database.

7. A method in accordance with claim 1 wherein said step of receiving the operational data from the data server with the data delivery device when the data server is in proximity to the data delivery device comprises the step of determining proximity by at least one of continuous or periodic radio polling by the data server, continuous or periodic radio polling by the data delivery device, reception of a head-of-train transponder by the data server, detection of an audible horn signal of the approaching locomotive, and detection of crossing activation signal from the crossing controller equipment.

8. A method in accordance with claim 5 wherein transmitting the operational data to a reception point comprises the step of determining proximity by at least one of continuous or periodic radio polling by the data server, continuous or periodic radio polling by the data delivery device, reception of a head-of-train transponder by the data server, detection of an audible horn signal of the approaching locomotive, and detection of crossing activation signal from the crossing controller equipment.

9. A method in accordance with claim 2 wherein the step of transmitting the operational data from the data delivery device to at least one of a computer system and a reception point, wherein the computer system is configured for one or more of parsing all operational data, associating operational data files and file fragments with particular remote sites, eliminating redundant files or fragments, resolving any errors, and reconstructing the original operational data files from each of the remote sites that include a data server.

10. A method in accordance with claim 11 wherein receiving the operational data from the data server with a data delivery device when the data server is in proximity to the data delivery device comprises:
mounting the data delivery device at an end of a train;
receiving, at the data server, a notification from grade crossing equipment or wayside equipment that the last car of a train has passed, signifying that the data delivery device is in a position to receive operational data from the data server; and
transmitting the operational data from the data server to the data delivery device.

11. A system for delivering railroad crossing and wayside equipment operational data, said system comprising:
at least one data server configured to:
collect operational data relating to railroad crossing equipment and wayside equipment;
configure the operational data into operational data files; and
transmit the operational data files;
at least one data delivery device configured to:
receive the operational data files from said data server when said data server is in proximity to said data delivery device; and
transmit the operational data files; and
an external communication system comprising at least one of a computer system attached to said data delivery device and a reception point in proximity to said data delivery device, said reception point communicatively coupled to a computer system, said external communication system configured to:
receive the operational data files; and
store the operational data files in a database.

12. A system in accordance with claim 11 wherein said data server is further configured to encode each operational data file with a data field that indicates what portions of the operational data files have been successfully delivered from said data server to said external communication system in a fragmented form.

13. A system in accordance with claim 11 wherein said data delivery device is mounted on a train.

14. A system in accordance with claim 13 wherein said reception point is further configured to:
receive the operational data files from said data delivery device when said data delivery device is in proximity to the reception point; and
transmit the operational data to said computer system.

15. A system in accordance with claim 11 wherein said data delivery device is further configured to transmit the operational data utilizing at least one of wireless data communication and hardwire data communication.

16. A system in accordance with claim 11 wherein one or more of said data server, said data delivery device, and said reception point are further configured to determine proximity by at least one of continuous or periodic radio polling by said data server, continuous or periodic radio polling by said data delivery device, reception of a head-of-train transponder by said data server, detection of an audible horn signal of the approaching locomotive, and detection of crossing activation signal from the crossing controller equipment.

17. A system in accordance with claim 11 wherein said computer system is further configured for one or more of parsing all operational data, associating operational data files and file fragments with particular remote sites, eliminating redundant files or fragments, resolving any errors, and reconstructing the original operational data files from each of the remote sites that include one of said data servers.

18. A system in accordance with claim 11 wherein said data delivery device and said data server utilize a spread spectrum radio link or a short range RF data network, allowing authentication of each operational data file or portion of an operational data file received by said data delivery device.

19. A system in accordance with claim 11 wherein said data delivery device is mounted on at an end of a train and powered by an end of train device.

20. A system in accordance with claim 19 wherein said data server is configured to be notified by grade crossing equipment and wayside equipment that the last car of a train has passed, signifying that said data delivery device is in a position to receive operational data files from said data server.
